(19) United States
(12) Patent Application Publication
(10) Pub. No.: US 2006/0064721 A1
(43) Pub. Date: Mar. 23, 2006

(54) Method and apparatus for implementing a synchronized electronic program guide application

(75) Inventors: David Del Val, Madrid (ES); Enrique Villar, Madrid (ES); Eduardo Mayor, Las Rozas (ES); Gonzalo Martin, Madrid (ES); Albert Daurell, Barcelona (ES); Eudald Domenech, Barcelona (ES); Marcel Coderch, Sant Cugat del Valles (ES); Jesus Fernandez, Madrid (ES); Edgardo Zunini, Barcelona (ES)

Correspondence Address: BAKER & MCKENZIE LLP;PATENT DEPARTMENT, 2001 ROSS AVENUE, SUITE 2300, DALLAS, TX, 75201, US

(73) Assignee: Techfoundries, Inc.

(21) Appl. No.: 11/223,355

(22) Filed: Sep. 9, 2005

Related U.S. Application Data
(63) Continuation-in-part of application No. PCT/SE04/00110, filed on Mar. 10, 2004.

(51) Int. Cl. H04N 5/445; G06F 13/00; G06F 3/00

(52) U.S. Cl. 725/41; 725/40

(57) ABSTRACT

The disclosed principles provide, in one aspect, an electronic program guide (EPG) that is synchronized in real-time with the actual programs that are being broadcasted on TV, radio, and other forms of media. Unlike traditional EPGs described in the prior art, the synchronized EPG updates the start and end time of TV programs not only before they occur, but also while they are being aired, and after they have finished. This real-time information is used by recorders to ensure that programs are recorded from their very beginning (and not before) until their very end, without missing parts of the programs. Unlike traditional EPGs, the synchronized EPG recognizes the fact that the exact program start and end times are often not known in advance, and conveys that information to the recorders as it becomes available. With this data, recorders can, for instance, extend the recording time of a tennis match that runs longer than expected.

This application claims priority from U.S. Provisional Patent Application No. 60/453,591 filed Mar. 10, 2003, U.S. Provisional Patent Application No. 60/453,523 filed Mar. 10, 2003, U.S. Provisional Patent Application No. 60/453,526 filed Mar. 10, 2003, U.S. Provisional Patent Application No. 60/453,590 filed Mar. 10, 2003, U.S. Provisional Patent Application No. 60/453,525 filed Mar. 10, 2003, Provisional Patent Application No. 60/453,522 filed Mar. 10, 2003, U.S. Provisional Patent Application No. 60/453,592 filed Mar. 10, 2003, U.S. Provisional Patent Application No. 60/453,597 filed Mar. 10, 2003, U.S. Provisional Patent Application No. 60/453,524 filed Mar. 10, 2003, U.S. Provisional Patent Application No. 60/453,594 filed Mar. 10, 2003, U.S. Provisional Patent Application No. 60/453,606 filed Mar. 10, 2003, U.S. Provisional Patent Application No. 60/453,628 filed Mar. 10, 2003 and U.S. Provsional Patent Application No. 60/462,621 filed Apr. 14, 2003. This application also claims priority to and is a continuation-in-part of International Patent Application No. PCT/ES2004/000110 filed Mar. 10, 2004, the disclosure of which is also hereby incorporated by reference.

### TECHNICAL FIELD

The present invention relates to systems and methods for accurately recording television programs from their actual beginning to their actual end, using an electronic program guide that is synchronized in real-time with the actual events being broadcasted or otherwise presented to the pubic.

### BACKGROUND

Since the invention of television, viewers have continued to ask one primary question: What's on TV? During the early days of television, only a few channels were available for viewers to tune in and watch. As this broadcast medium continued to gain popularity, more and more channels were added to the broadcast line-up, giving viewers a greater variety of programming. Eventually, as digital terrestrial, cable and satellite systems became widely available, hundreds of channels have become available to viewers. As may be expected with so many channels, answering the question of what's on TV has become increasingly complicated.

Programming guides for informing viewers of upcoming programming have also seen dramatic change as time has passed. Initial guides were primarily printed guides, such as those found in newspapers or periodicals devoted almost exclusively to programming information (e.g., TV Guide™). As technology continued to improve, on-screen guides for use in displaying programming information to viewers (i.e., an electronic programming guide (EPG)) were introduced and have continued to be used today. EPGs are beneficial to viewers because they allow viewers to quickly scroll through the numerous channels available with today's modem technology, such as satellite, cable, and digital terrestrial TV receivers.

Conventional EPGs have disadvantages because they do not account for last-minute programming changes, such as the rescheduling of complete programs to other times or even other days entirely. Moreover, conventional EPGs are not configured to inform viewers of delays in programming, such as when normally scheduled programming is pushed back because other televised events go past their allotted time. Such occurrences result in an inconvenience to viewers who tune in at scheduled times to view their desired programming.

Although those viewers may simply continue checking back to finally view their programs, many viewers employ media recording devices, such as video cassette recorders (VCRs), personal video recorders (PVRs), and digital video recorders (DVRs), to record their programming for viewing at a later time. These viewers suffer more than a mere inconvenience when they miss portions of their programming due to unforeseen delays in the broadcast schedules. In some cases, viewers miss the end of their recorded programs because they run a bit longer than expected by the EPG. In other cases, these viewers miss their programs altogether when they are preempted to different times or completely different days.

Some commercial systems address this issue by making sure that the recording starts a few minutes before the program is supposed to start, and ends a few minutes after the program is scheduled to end. Although this approach works some times, it often fails because for many programs, it is impossible to know in advance for how long the recording should be extended. In addition, this approach unnecessarily wastes data space in the recording medium, and has the annoying side effect that all recordings start with a few minutes of the program or the advertisings that were aired before the program that the user is recording.

Some other prior art, such as U.S. Published Application 2002/0110360A1, claims that the EPG data can be continuously updated by changing the start time of the events and by identifying when scheduling changes occur. This solution is only partially valid, because it does not address when these updates have to be sent, what to do with ongoing recordings affected by small overruns or delays, and how to solve the problem of sequential recordings.

### SUMMARY

The disclosed method and apparatus provide, in one aspect, an electronic program guide (EPG) that is synchronized in real-time with the actual programs that are being broadcasted on TV, radio, and other forms of media. Unlike traditional EPGs described in the prior art, the synchronized EPG updates the start and end time of TV programs not only before they occur, but also while they are being aired, and after they have finished. This real-time information is used by recorders to ensure that programs are recorded from their very beginning (and not before) until their very end, without missing parts of the programs. Unlike traditional EPGS, the synchronized EPG recognizes the fact that the exact program start and end times are often not known in advance, and conveys that information to the recorders as it becomes available. With this data, recorders can, for instance, extend the recording time of a tennis match that runs longer than expected.

Another aspect of this invention generalizes this idea of marking the exact start and end time of a program, and also includes the marking in real-time of any other significant event that occurs during a program, such as a goal in soccer or a homerun in baseball. These program annotations can also indicate, for instance, when a commercial break occurs during a program. These annotations allow a user to easily move to relevant portions of a recorded program.

This invention also discloses a method to use all these EPG updates and annotations to resolve recording conflicts that arise when more than one program is to be recorded, but there are not enough tuners in the system to receive all the programs that have to be recorded at once. The method distinguishes between overlapping programs and partially abutting programs.

Another relevant feature of the disclosed method and apparatus is the ability to identify specific broadcast programs based upon a variety of search or mood factors. Some of these factors can be based upon user preferences, such as user-provided viewing preferences, user-provided demographic data, or a user's viewing history. According to another embodiment, a user may select content to be viewed or recorded based upon a particular mood, such as entertainment, educational, inspirational, or romance. These program selection features can be implemented either at the server level or at the client level for an added level of security.

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 illustrates a conceptual block diagram illustrating various techniques in accordance with an exemplary embodiment;

FIG. 2 illustrates one embodiment of an environment in which the disclosed technology can be utilized;

FIG. 3 illustrates an exemplary embodiment of a synchronized EPG Server, in accordance with the disclosed principles;

FIG. 3A illustrates a representative embodiment of an electronic program guide database;

FIG. 3B illustrates a process by which a “full update” is performed;

FIG. 3C illustrates a representative process flow of a “schedule update”;

FIG. 3D illustrates a representative process flow of a “trim update”;

FIG. 3E illustrates a representative process flow of an “annotation update”

FIG. 4 illustrates an exemplary screen shot of an electronic program guide;

FIG. 5 illustrates one embodiment of a process flow for conflict resolution of multiple scheduled recordings; and

FIG. 6 illustrates an exemplary prioritization subroutine for a conflict resolution process performed in accordance with the disclosed principles.

### DETAILED DESCRIPTION

The present invention relates to systems and methods for recording television programs from their exact beginning to their actual end, with a precision of less than a second. To achieve this goal, a synchronized electronic program guide (EPG) is assembled in a central server and sent to recording devices over a data network. As the TV programs are aired, the recording devices get real-time updates of the EPG and use this information to modify the recording time of the scheduled programs.

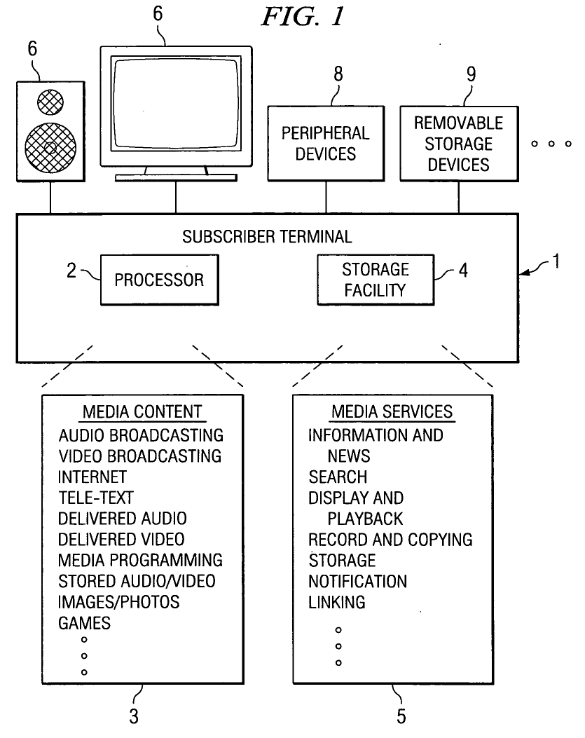

FIG. 1 illustrates a conceptual block diagram illustrating various techniques in accordance with an exemplary embodiment. A subscriber terminal 1 is associated with one or more users or subscribers at a given location. That terminal 1 is provided with a storage facility 4, such as a hard disk drive, and a processor 2.

Various exemplary output devices are coupled to the subscriber terminal 1 for rendering or storing media content supplied by the terminal 1. For instance, an audio output device, such as a speaker 6, may be coupled to the terminal 1 to render audio for hearing by the user. Similarly, a display 7, such as a television set, may be coupled to the terminal 1 to render video (having associated audio tracks) for viewing (and hearing) by the user. Peripheral devices 8, such as, for example, game stations, camcorders, and other devices, as well as removable storage devices 9, such as CDs, DVDs and the like, may also be coupled to the terminal 1 to respectively store or render media content.

In addition, a wide array of media content 3 is identified in FIG. 1. Broadcast video—such as channels broadcast by satellite and cable operators (for example, DirecTV and Comcast) together with free-to-air video provided via conventional antennas—is one form of media content 3. Broadcast audio, as presently supplied via conventional antennas or more recently by satellite operators (for example, XM radio) are another form of media content 3. Internet content, as found on various websites, and related media programming are yet other types of media content 3 supplied to the terminal 1, which is supplied upon request by a user as opposed to at a scheduled time, are still other types of supplied media content 3. Other examples of supplied media content 3 include tele-text, stored audio and/or video (for example, DVDs and compact discs), images and/or photographs, and games.

Media services 5 associated with the diverse types of supplied media content 3, including related information, are also supplied to the subscriber terminal 1. Such media services 5 provide a user with management and control type functions in conjunction with the supplied media content 3. As identified in FIG. 1, diverse different media service 5 type functions are presented to a user. Such media services 5 may include, but are not limited to, informational and news related functions (for example, programming information, guides, commentary, textual messaging, news alerts); search related functions and queries; display and playback related functions (for example, program selection, fast forwarding, and time shifting); recording and copying related functions; storage related functions (for example, storage and retrieval of files, organizing files, and cataloguing type functions); notification related functions (for example, alarms and alerts); commerce related functions; and linking related functions.

Since it is common that multiple media sources are supplied or otherwise provided to a subscriber through various operators, the ability to provide for an integrated system to allow a user to manage the above mentioned media content 3 so as to avoid having to employ multiple different systems, is highly desirable.

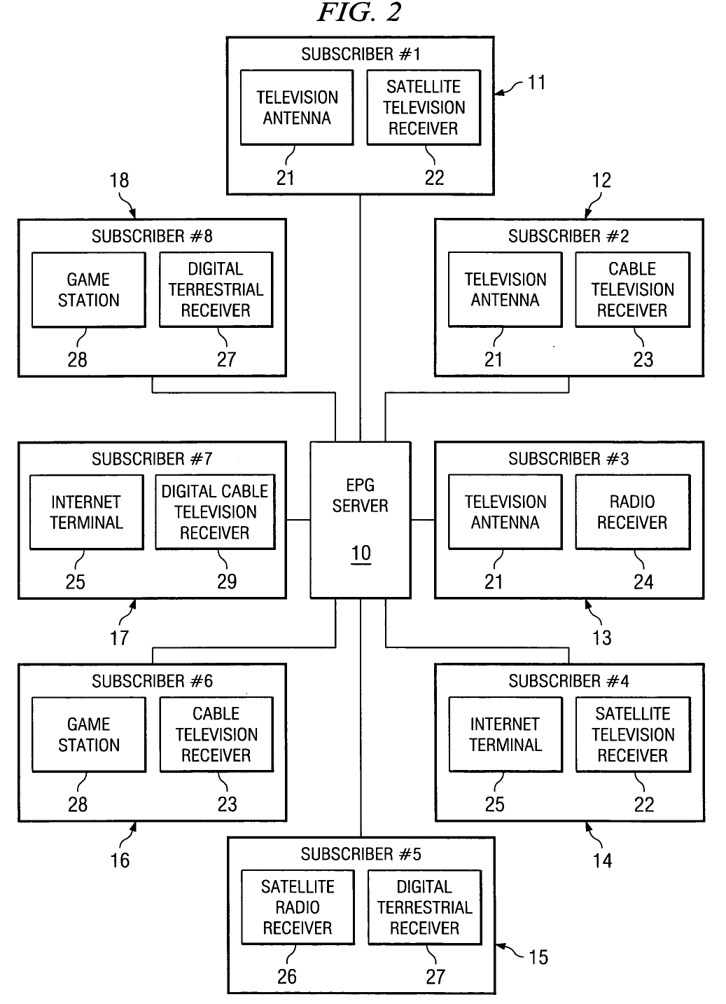

Referring now to FIG. 2, the environment in which the disclosed technology can be utilized is illustrated, in accordance with an exemplary embodiment. An electronic program guide (EPG) server 10 is operable to distribute various programming and other information, as well as applications to process such information, to various geographically dispersed outlets, i.e. user premises or households. An outlet may be supplied by a single media source or by multiple diverse media sources.

Exemplary outlets 11-18 are illustrated in FIG. 2. These exemplary outlets 11-18 each access one or more media sources: outlet 11 includes a TV antenna source 21 and a satellite TV receiver 22 for subscriber #1; outlet 12 includes a TV antenna source 21 and a conventional cable TV receiver 23 for subscriber #2; outlet 13 includes a TV antenna source 21 and a conventional analog radio receiver 24 for subscriber #3; outlet 14 includes an internet terminal 25 and a satellite TV receiver 25 for subscriber #4; outlet 15 includes a satellite radio receiver 26 and a digital terrestrial receiver 27 for subscriber #5; outlet 16 includes a game station 28 and a conventional cable receiver 23 for subscriber #6; outlet 17 includes an internet terminal 25 and a digital cable TV radio receiver 29 for subscriber #7; and, outlet 18 includes a game station 28 and a digital terrestrial receiver 27 for subscriber #8.

The TV antenna source 21 is the source by which broadcast television signals transported between antennas are provided to an outlet 11-18. In contrast, the satellite TV receivers 22, conventional cable receivers 23, and digital cable TV receiver 29 are receivers respectively associated with conventional satellite and cable distribution systems. Similarly, the radio receiver 24 is a conventional radio receiver that receives RF audio signals via an antenna.

It should be appreciated that the various outlets 11-18 and associated media sources illustrated in FIG. 2 are merely exemplary. That is, the server 10 is intended to be operable with any outlet configuration and diverse media sources, whether presently used or intended to be use in the future. The ability to continually adapt applications and servicing information for new or later adapted media sources is an advantage provided by this distributed architecture in which the server 10 may continually reconfigure the associated applications and data.

It should also be appreciated that while a singular EPG server 10 has been referred to above, multiple servers may provide the various functions described with respect to that EPG server 10. For example, when using multiple servers, each server may be assigned a particular functionality; that is, one server may handle programming information for one or more different media sources while another server may handle billing type applications and services.

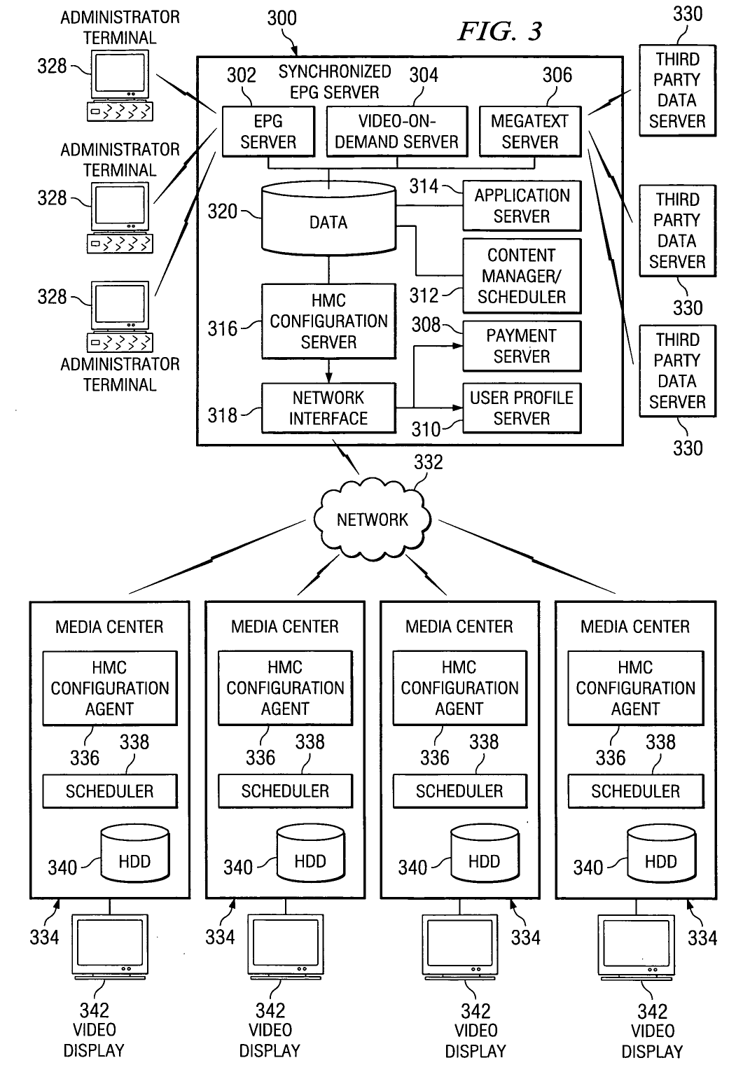

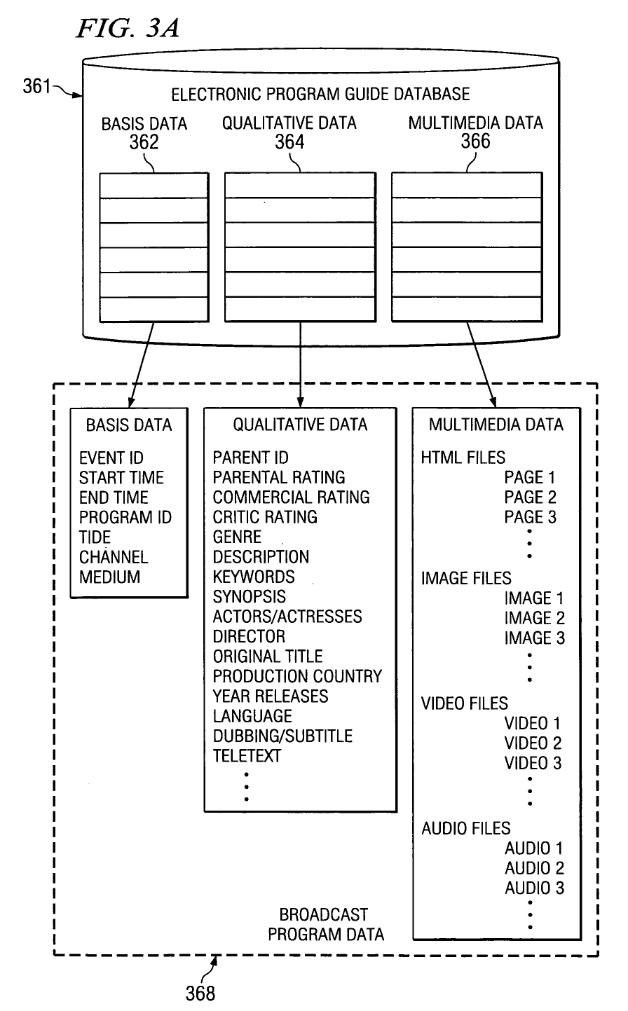

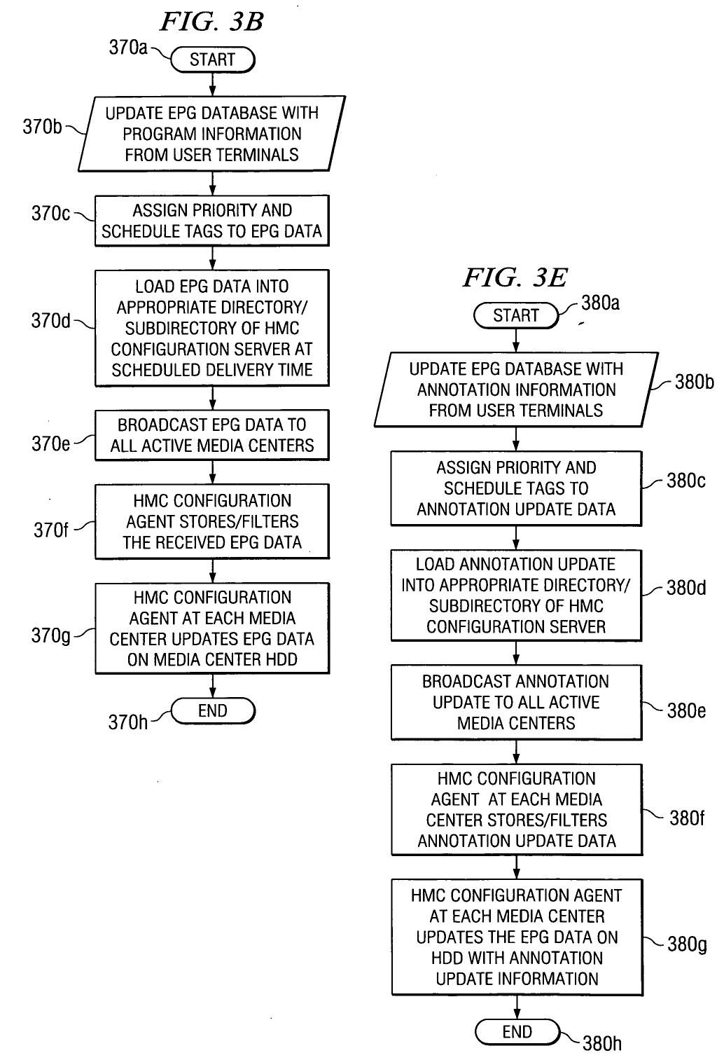

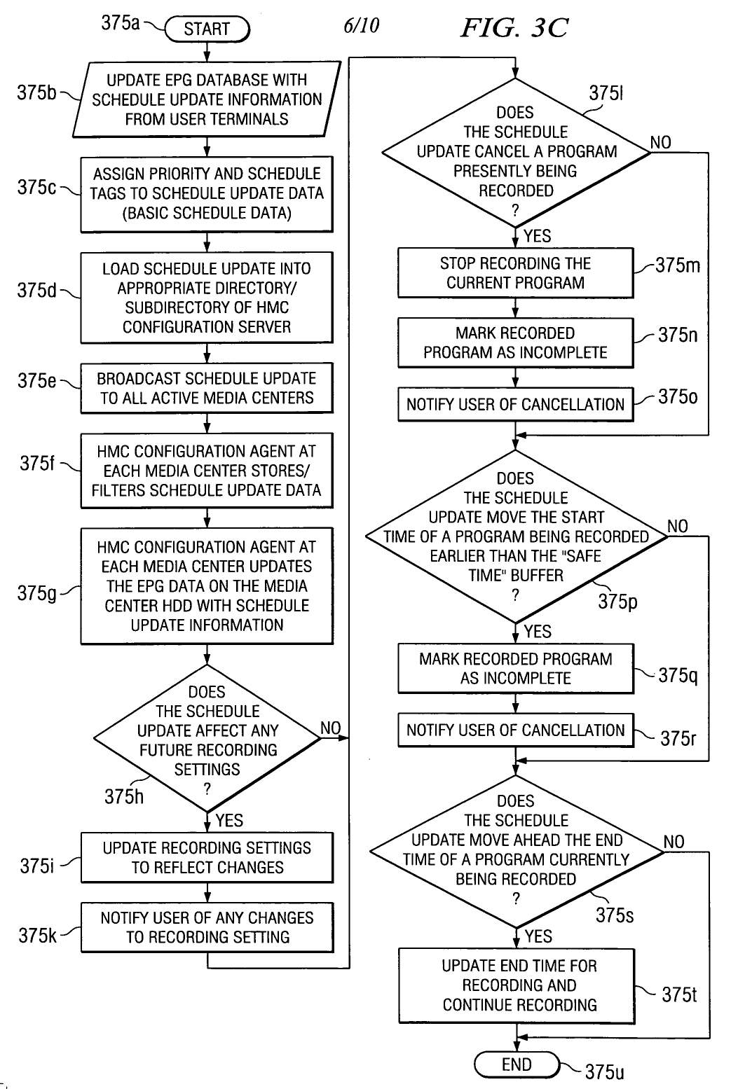

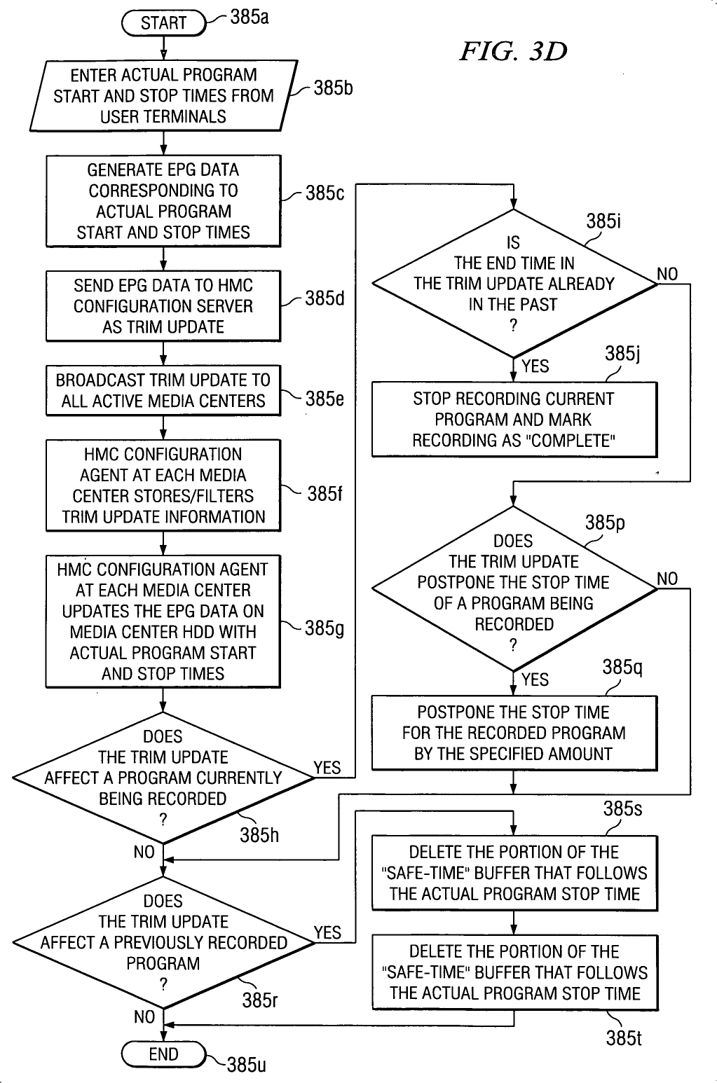

A representative embodiment of the synchronized EPG Server where the synchronized EPG is assembled is depicted in FIG. 3. In FIG. 3, the synchronized EPG server 300 is depicted as comprising several components including a program guide server 302, a video-on-demand server 304, a megatext server 306, a payment server 308, a user profile server 310, a content manager/scheduler 312, a home media center (“HMC”) configuration server 316, a network interface 318, and a data repository 320. The program guide server 302, the video-on-demand server 304, a megatext server 306, the content manager/scheduler 312, and the application server 314 are all connected to a centralized database repository 320 so that data can be stored, modified and moved within the repository 320. In addition, the program guide server 302 can be connected to one or more administrative terminals 328 to receive information provided by an administrator. The megatext server 306 can also be connected to third party data servers 330, which are used to provide data to the megatext server 306 in either a push, pull, or direct feed format.

The synchronized EPG server 300 is operable to communicate through a communications network 332 with one or more recording devices 334, also called media centers. The communications network 332 may comprise any of a variety of packet-based communications systems, such as digital satellite, digital cable, digital terrestrial, or telephony-based networks such as ADSL and its successors. Each of the media centers 334 comprises at least one hard disk drive (HDD) 340, an HMC configuration agent 336, and a recordings scheduler 338. Also connected to each media center 334 is a display device 342 that may comprise a television set, a flat screen display, or any other kind of visual display system.

The program guide server 302 is operable to receive data from one or more administrative terminals 328. Each of these administrative terminals 328 is manned by an individual that is keying in data regarding current and future broadcast programs in real-time with the programs. The broadcast programs can include a variety of broadcast formats such as satellite television, cable television, analog television, or digital terrestrial television. Each of these formats could be covered by a single electronic program guide. The data provided by the administrative terminals 328 can comprise a variety of information, including the start and stop times of a program, title, genre, a description, and keywords associated with that program. As this data is provided to the program guide server 302, it is loaded into the associated database repository 320. The data relating to programs currently being broadcast is immediately processed by the scheduler and the HMC configuration server and sent to the media centers right away in real-time.

The video-on-demand server 304 is utilized to “push” video content onto each of the respective media centers 334 so that it can be accessed by a user of a media center 334 at his/her convenience. This video content can be in the form of full-length feature movies, interactive channels, or shorter video clips, such as television programs or advertisements. In order to efficiently transmit this video content to the media centers 334, the video content can be broken up into smaller segments and compressed according to formats, such as ZIP or MPEG. After this, the video content is stored in the database repository 320 until it is determined that it should be transmitted to the media centers 334. According to one embodiment, a new feature length movie can be transmitted and saved to each of the media centers 334 every day.

As described previously, the megatext server 306 receives data from one or more third party data servers 330. The megatext server 306 can also receive data directly from a terminal at the media server 300. The third party data servers 330 can provide a variety of data, including, sports updates, news, traffic, weather, horoscopes, jokes, etc. Although the data received from these third party servers 330 can be in a variety of formats, the data may be converted into a single standardized format, where the preferred format for data received from third party servers 330 is XML. After the data has been received and converted by the megatext server 306, it can be merged with a template providing its formatting and arrangement, such as an XSL file, to create a megatext file. After being merged with a template, the megatext file is stored in the database repository 320. At certain designated times, the megatext files are “pushed” from the database repository 320 to each of the media centers 334. Each of these megatext files can be considered “dynamic data” because it may be continuously updated with new information. This “dynamic data” can be merged with certain “static data” at each of the media centers 334 to form a rich multimedia experience that is presented to the user on his/her video display 342.

The content manager/scheduler 312 is operable to assign certain tags or identifiers associated with the files in the database repository 320. These tags can comprise a variety of information, such as a priority associated with the file, a target ID indicating which media centers 334 should accept files, and a schedule as to when the file should be broadcast to the media centers 334. Some of the target ID can include a box ID corresponding to a specific media center 334, a community ID corresponding to a group of media centers 334 sharing a common factor or similar demographic information, corresponding to a particular subset of users meeting certain demographic criteria. Accordingly, the content manager/scheduler 312 determines what data will be provided to each of the media centers 334 and when the broadcast will occur.

The HMC configuration server 316 acts as a broadcast queue such that EPG data that is stored therein will be immediately queued for broadcast through the communications network 332 via the network interface 318. The network interface 318 comprises an interface between the servers in the media server 300 and a packet-based communications network 332. According to one embodiment, the network interface 318 utilizes an internet-related protocol, such as TCP/IP or UDP/IP, so that the data may be provided over any of a variety of packet-based communications networks.

The HMC configuration server 316 also performs several functions that dictate how EPG data is broadcast from the synchronized EPG server 300 to the media centers 334. More specifically, the HMC configuration server 316 allocates the amount of bandwidth that will be available for transmission of a certain data packet. According to one embodiment, the HMC configuration server 316 uses the priority tags that have been associated with a particular file to determine how much bandwidth should be assigned for the transmission of that file. For example, if three kinds of priority tags are associated with the data (high, medium, and low), all data being marked with the top priority will be broadcast first, then all data marked with the second priority, followed by all data marked as third priority. If a data file marked as first priority is loaded into the HMC configuration server 316 as a group of second priority data files is being transmitted, then the transmission of these second priority data files will be interrupted and the first priority data file will be sent.

Therefore, the HMC configuration server 316 essentially serves as a batch distribution buffer. In other words, as soon as EPG data is loaded into the HMC configuration server 316 it will be broadcast from the network interface 318 in accordance with the priority associated with the data. Accordingly, data may not be loaded into the HMC configuration server 316, until the designated time provided by the content manager/scheduler 312.

As the communications network 332 might consist on a non-reliable network where data packets might be lost or corrupted, the HMC configuration server 316 is also responsible for the implementation of data protection mechanisms as, for instance, forward error correction. As is well known in the art, one way of performing forward error correction is to repeat the transmission of a set of data packets until all of the recipients have received a complete set of the data packets. Accordingly, the HMC configuration server 316 can instruct the network interface 318 to automatically repeat the transmission of certain types of data to ensure that all data packets are received by the media centers 334.

Another form of error correction that is implemented by the HMC configuration server 316 is cyclic redundancy check (CRC) error correction so that the integrity of each data packet can be confirmed when it is received. The network interface 318 comprises an interface between the servers in the synchronized EPG server 300 and a packet-based communications network 332. According to one embodiment, the network interface 318 utilizes an internet-related protocol, such as TCP/IP or UDP/IP, so that the data may be provided over any of a variety of packet-based communications networks.

Although the previously described servers are utilized to provide data to the media centers 334, the media server 300 also comprises servers that receive data from the media centers 334. In particular, the user profile server 310 receives, sorts, and stores data related to users of the media centers 334. This data is provided by a user when his/her corresponding media center 334 is initially activated. Such data can include user name, address, demographic information, billing information and viewing preferences. According to one embodiment, this profile information may be periodically updated by selecting additional information at each of the media centers 334 and transmitting that information to the media server 300.

Also depicted in FIG. 3 is a payment server 308 that receives data from the media centers 334. The payment server 308 is used to process billing information for any additional products or services ordered by a user at his or her media center 334. The payment server 308 can be connected to a credit card or debit card processing network (not shown), or it can be used to keep a running account of the additional services and products purchased by a user. In one embodiment, a media center 334 will keep a running count of all goods and services purchased by a user during a month. At the end of the month, the media center 334 will transmit these purchases to the payment server 308 in the media server 334 so that the user will be properly billed for these costs.

As described previously, the communications network 332 can comprise any of a variety of packet-based communication networks, including, for example, digital satellite, digital cable, digital terrestrial, or telephony-based networks. If a satellite communications network is utilized to transmit data to the media centers 334, then it is likely that an alternative communications network, such as dial-up Internet access, will be used as an upstream communications path. Other aspects of the media system 300 will be described in further detail below.

A representative embodiment of an electronic program guide database 361 is depicted in FIG. 3A. In FIG. 3A, the EPG database 361 is depicted as comprising three components: a basic data folder 362; a qualitative data folder 364; and a multimedia data folder 366. The depicted embodiment of the EPG database 361 is a relational database in which information corresponding to a single broadcast program will be stored in each of the three depicted folders. For example, the start time, end time, title, program ID, channel, broadcast medium, and event ID corresponding to a particular program will be stored in the basic data folder 362. Other data corresponding to that broadcast program, such as parental rating, commercial rating, critic rating, genre, and description, inter alia, will be stored in a corresponding entry in the qualitative data folder 364. Lastly, multimedia data 366 corresponding to the particular broadcast program, such as an HTML file, an image file, a video file, or an audio file, will be stored in a corresponding multimedia data folder 366.

The data that is stored in the EPG database 361 can be stored according to a variety of formats including, for example, XML. This data can be provided to the EPG database 361 by individuals at the administrative terminals 328, or it can be provided automatically by the broadcaster of the particular program. Although some of the data stored in the EPG database 361 is fairly standardized (such as a program's title, start time, end time, channel and medium) a great deal of the content contains unique and creative content. For example, the EPG database 361 contains keywords, HTML pages, video files, and critical ratings associated with many of the broadcast programs stored in the database 361.

As described in the co-pending and co-owned patent application entitled “Integrated Media Techniques and System,” the media centers 334 can receive and manage content from a wide variety of sources. For example, each media center 334 is operable to manage content from a variety of pay-TV sources, such as digital cable, digital satellite, and digital terrestrial sources. Each of these pay-TV sources can have a variety of subscription packages available to the user. For instance, some subscribers of a digital satellite TV service may only subscribe to a basic package that provides “basic cable” channels, such as news, music videos, and regional sports networks. Other subscribers, however, may purchase channels from more than one satellite and have a much broader selection of channels. Furthermore, the availability of certain channels will vary based upon the geographic location of the media center 334. Accordingly, each user of a media center 334 is likely to have a highly individualized list of channels that are available.

It is desirable to provide updated programming information to all users so that they are aware of programming changes, new channels, and changes in program start and stop times. This is somewhat complicated by the highly-individualized list of channels that are available to users of the system. Indeed, it is preferable that a user's “available channel list” be automatically updated whenever new channels are added to his broadcast region, or when channels are added or removed from his pay-TV subscription package. The disclosed system and apparatus can use a variety of techniques to automatically maintain this “available channel list” and update the user's programming guide so that only the relevant information is presented to the user in his/her programming guide window.

According to one embodiment, maintenance of the “available channel list” and preparation of a personalized programming guide is done at the client side of the server-client arrangement depicted in FIG. 3. The first step of this process occurs when the media center 334 is being utilized and searches all of the RF channels that are available to it. Each of the available RF channels is stored within the user's “available channel list” in the media center 334. Next, the user is queried to determine if he/she subscribes to any pay television services (e.g., digital satellite, digital cable, digital terrestrial, etc.). The user then selects the pay-TV service and the specific package (e.g., basic package, premium package, movie channel package, etc.) to which he/she subscribes. Based upon this information, the media center 334 generates a complete “available channel list” (the user's personalized view of the EPG) that is stored in the media center 334. A complete set of all EPG data is then broadcast to each of the media centers 334. This complete set will contain data related to all channels and all programs, regardless of whether this data is included in the “available channel list” for a particular user. Although an entire set of EPG data is stored in each media center 334, the media center 334 will only present the data relevant to the user's “available channel list” when the user requests information about his personalized programming guide. Accordingly, the “available channel list” acts as filter at the media center 334 to present only those channels that are relevant to a particular user.

From time-to-time, the content providers may change the listing of channels that are available for a particular package of pay-TV services. For example, the content provider could change the channels available in a “basic cable” package or add new channels to a “premium package” service. When this occurs, a “package update” will be sent from the media server 300 to each of the media centers 334 describing the changes in the particular package to which the user subscribes. This package update is used to update each user's “available channel list” so that the user is automatically made aware of any programming changes. In this manner, a change in the available channels for a package will be automatically implemented on a user's media center 334 without any involvement by the user. In addition, the framework for the “available channel list” can be configured by the user to place the broadcast channels in a certain order and to form groups of related channels. This arrangement is advantageous to the user because it allows him to arrange the channels in the order that are most convenient to him/her.

According to another embodiment, maintenance of an “available channel list” and preparation of a personalized program guide can be done at the server side of the server-client arrangement depicted in FIG. 3. The first step of this process is to update and store a complete version of the EPG database 361 in the database repository 320 of the media server 300. After a complete EPG database 361 is updated and stored in the database repository 320, the media server 300 will create different versions of the EPG data corresponding to the variety of regional differences and package subscriptions that are available to the users of the media centers 334. Next, target IDs corresponding to individual media centers 334 or media center communities are associated with the different versions of the EPG data. After all of the targeting information has been assigned, all of the versions of the EPG data will be broadcast to all of the media centers 334. Each of the respective media centers 334 will use the targeting information to filter out which versions of the EPG data are relevant to it and which versions should be disregarded. The accepted version(s) of the EPG data will be stored in the media center 334 and thereby made available to the user when so requested. By preparing the versions of the EPG data at the server side, new versions of the subscription packages need not be broadcast to all of the media centers 334. Instead, the subscription package need only be updated at the server and the appropriate versions of the EPG data will be broadcast to the relevant media centers 334.

Once the media center 334 receives the EPG data sent through the communications network 332, this data can be presented to the user on the display device 342 to allow the user to select what programs should be recorded. When a program has been selected to be recorded, the media center 334 can utilize a “safe time” buffer before and after each recording in case the program starts early or runs late. For example, if the user selects a program for recording that is scheduled to begin at 7:00 p.m. on Thursday evening and end at 8:00, then the media center 334 will automatically begin recording at a “safe time” (i.e., 10 minutes) before the program begins. In addition, the media center 334 will also continue to record the program for a “safe time” (i.e., 10 minutes) after the scheduled end of the program. By using these safe times, the media center 334 tries to ensure that no portion of the program is missed from either its beginning or end.

However, many times the programming changes so radically that the safe time mechanism is not enough to ensure that the recordings are carried out correctly and accurately. One aspect of the electronic program guide is the ability to synchronize EPG data on a user's media center 334 with the actual programming that is being broadcast. By synchronizing the user's EPG data, a variety of rich features can be implemented. According to one embodiment, the disclosed system utilizes four different kinds of program guide synchronization data: a “full update” synchronization, a “schedule update” synchronization, a “trim update” synchronization, and an “annotation update” synchronization. Any of these updates may be provided to the media centers 334 without any prompting for updates or updated data by the media centers 334. As a result, the updates may be made in real-time as programming changes are detected, particularly since the location of the media centers 334 (e.g., in a home) makes it difficult or even impossible for the media centers 334 to determine that an update is even required. Each of these synchronization updates are summarized and described in detail below.

A “full update” synchronization is used to fully update the EPG data stored in the media center 334. Full updates erase all the previous EPG data stored on the media center and may be carried out once or twice per day. A “schedule update” synchronization can be used to handle a situation where a program has been moved to another time slot, has been cancelled, or will be preempted by other programming, such as a newscast. Schedule updates can also be used to handle the situation where a particular program is running longer than its scheduled time-slot. If such a situation arises, a schedule update can be sent to the media centers 334 informing them that the stop time for the program will actually be later than planned, thereby instructing in real-time any media centers 334 that are recording the program to keep recording. In this manner, the media centers 334 can automatically adjust their recording feature in real-time with the programming in order to capture the entirety of a program that runs long. The schedule update will comprise basic data describing the latest changes in the broadcast programming. According to one embodiment, a schedule update will be broadcast from the synchronized EPG server 300 up to a hundred times per day, as programming schedules in the different channels are changed, and as programs run late.

Another kind of synchronization that can occur is a “trim update,” which is sent after a program has finished and updates the EPG data stored in the media centers 334 with the actual start and stop times of the particular broadcast program. By synchronizing the EPG data in the media center 334 with the actual start and stop times, any material recorded before the start and after the stop of the desired program can be trimmed, thus making viewing of the program more convenient for the user and saving precious disk space.

Finally, an “annotation update” synchronization is used to add annotations to broadcast programs that enable convenient features for a user. Preferably, annotation updates are broadcast to the media centers 334 while the program is being broadcast. However, annotation updates can be sent before or after the completion of a program. Annotation data can include timing that corresponds to certain events in the program, such as periods or quarters in a sports program, commercial interruptions, or particular segments in a news program (e.g., headlines, weather, sports, etc.). The annotation synchronization process takes place when one or more annotation updates are broadcast from the synchronized EPG server 300 to the media centers 334, and may also be made in real-time with the events being annotated in the program being recorded.

A variety of other features are enabled by the qualitative data 364 that is included in the EPG database 361. For example, features such as a program search function, a program “mood” search feature, matching of broadcast content with a user profile, and a synchronized electronic program guide can be implemented. Each of these features is described in more detail below. The program search function allows a user to search for broadcast content that matches specific search criteria. The searching and matching features use the keywords, genres, descriptions and other information in order to identify specific content for processing. Because the qualitative data 364 contains a variety of data, the search feature can be highly customized. For example, a user may desire to search for action movies (genre) that are suitable for all family members (low parental rating). By providing this information to the search engine of the media center 334, broadcast content matching this criteria can be identified in the EPG data. Once the results of the search are presented to the user, he/she can select programs from the results list for reminders, viewing, or recording.

In another embodiment, a “mood search” feature can be utilized. The mood search feature uses certain mood keywords to find broadcast content that is consistent with a mood of the viewer. This feature, of course, requires that appropriate keywords be associated with content categories and subcategories in the EPG database 361. A representative example of mood categories and their associated categories and subcategories is listed below in Table 1. The information depicted in Table 1 can be utilized as follows. A user would request educational content and would thereby be presented with a list of news, programs, series, and movies that have education content. According to another aspect, a user could request all broadcast content that is “inspirational” would be presented with a list of programs that have an inspirational keyword associated with it.

TABLE 1

| Mood | Category | Subcategory |
|---|---|---|
| Good Movies | Movies | All |
| Adventure | Series | Action & Adventure |
| Educational | News | Other |
| | Programs | Cultural Documentary |
| | Series | Drama |
| | Movies | Other |
| Sports | News | Sports |
| | Sports | All |
| Fun | News | Humor |
| | Programs | Humor |
| | Series | Comedy |
| | Movies | Comedy |
| Entertainment | Movies | Programs, Western, Drama, |
| | | Suspense, Film Noir, Other |
| | News | News |
| | Programs | Talkshows, Interviews, |
| | | Contests, Teenagers, Society, |
| | | Culture, Variety, Debates, |
| | | Reality |
| | Series | Fiction, Animation, Drama, |
| | | Teen, Mystery, Professional, |
| | | Western, Soap Operas, Comedy, |
| | | Action/Adventure |
| Erotic | Series | Erotic |
| | Movies | Adult |
| Soccer | Sports | Soccer |
| Children/Family | Series | Children, Animated |
| | Movies | Children |
| Information | News | Notices, Weather, Reports, |
| | | Interviews, Debates, |
| | | Economics, Politics, Other |
| Music | Programs | Music, Cultural |
| | Movies | Musical |
| Romance | Series | Soap Operas |
| | Movies | Romantic |

Another useful feature is the matching of broadcast content with certain users based upon information stored in the user profiles. This matching feature can occur at the media server 300 level, at the media center level 334, or at both levels, depending upon the specific embodiment. The first example, matching at the EPG server 300 level, is described below.

The first step of matching at the EPG server 300 level is to create a user profile corresponding to a specific user. The user profile may be comprised of a variety of data, such as user profile data provided by the user, demographic data provided by the user, or user viewing history data provided by the media center 334. The matching process can be handled by the user profile server 310 depicted in FIG. 3. After the user profile is created, the content manager/scheduler 312 may occasionally query the user profile server 310 to determine if there are any users or communities that would find a particular program to be of interest. For example, a sports program featuring a city's team would likely be of interest to all users from that city. Accordingly, the content manager/scheduler 312 would place a tag in the program database corresponding to the relevant users or community. As a result, when the EPG data corresponding to this program is transmitted to the media centers 334, all media centers 334 corresponding to the tagged users or tagged communities would receive a special note regarding the program. This special note can be in the form of a window that is presented to the user when he/she accesses the EPG.

The matching feature can also be implemented at the media center 334 level. According to this process, the HDD 340 at the media center 334 would further comprise a user profile database. This user profile database can comprise demographic information, viewing history, or viewing preferences. The types of information stored in the user profile database can be configured by the user based upon his/her preferences. Furthermore, by keeping the user profile information at the media center level, the user will have fewer concerns about maintaining the privacy of his/her demographic information, viewing preferences, and viewing history. As EPG data is provided to the media center 334, the HMC configuration agent 336 can utilize the user profile information to select program content that may be desirable to a particular user, and discard program content that is not. If certain programs are found to be desirable to a user, the user could receive a special note regarding the program when viewing the EPG. This special note can be in the form of a window that is presented to the user when he/she accesses the EPG.

We now describe in greater detail each of the different exemplary synchronization updates. The process by which a “full update” of the electronic program guide database is performed is depicted in FIG. 3B. A “full update” will generally be performed at least once a day. In FIG. 3B, the process starts (370a) by first updating the EPG database 361 at the synchronized EPG server 300 with program information from the administrative terminals 328 (370b). This data can either be entered manually, or it can be automated based upon data provided by the broadcasters, but in either case is typically provided in real-time with changes made to the scheduled programming. Next, depending upon the specific embodiment, the content manager/scheduler 312 assigns priority, target data, and a schedule for the delivery of the EPG data to the media centers (370c).

After all of the data corresponding to a particular broadcast program has been loaded into the database repository 320, a revised electronic program guide is prepared for transmission to the individual media centers 334. At the designated time, the EPG data will be loaded into an appropriate directory or subdirectory of the HMC configuration server 316, which acts as a transfer queue for the network interface 318 (370d). After this, the EPG data is broadcast to all active media centers 334 (370e). The broadcast of the EPG data from the synchronized EPG server 300 to media centers 334 will typically take place at a time of low network activity.

Depending upon the specific embodiment, the full update will either contain a full set of the EPG data or will contain a plurality EPG data versions, each of which having target ID associated therewith. Accordingly, the EPG data from the full update will be received and processed by the HMC configuration agent 336. If one or more packets of information are missing from a particular transmission, then the HMC configuration agent 336 will wait through two cycles of transmission of the EPG data to ensure that all of the necessary data packets are present. Next, depending upon the embodiment, the HMC configuration agent 336 at each media center 334 will discard all unnecessary EPG data based upon targeting information (370F). After this, the remaining broadcasted EPG data will be stored on the HDD 340 of each media center 334 (370G). At this point, the full update of the electronic program guide database 361 is complete (370H).

As stated previously, a full update of the electronic program guide database 361 will generally be broadcast once a day from the synchronized EPG server 300 to the media centers 334. However, there will often be a need to update partial schedule data and other information throughout the day as the broadcasters make small changes in their schedules. These changes can include breaking news flashes or last-minute programming changes. To address these changes, the media center 334 and synchronized EPG server 300 are capable of performing a “schedule update” several times throughout the day that are in real-time with the changes made to the programming.

“Schedule updates” can also be used to address the situation where an existing program is running long. For example, a sporting event may run into overtime or a live program may run long. In these situations, existing video recorders that do not receive real-time schedule updates would stop recording at the previously scheduled stop time. A media center 334 equipped with the disclosed “schedule update” feature, however, would be able to receive commands in real-time with programming changes that can instruct it to continue recording a program that runs long.

A representative process flow of a schedule update is depicted in FIG. 3C. In FIG. 3C, the process starts (375a) by first updating the electronic program guide database 361 with real-time program information from the administrative terminals 328 (375b). These real-time updates can reflect the changes in programming described above or any other type of update that is being provided. After the EPG database 361 has been updated at the synchronized EPG server 300, the content manager/scheduler 312 assigns any necessary tags such as priority, delivery schedule, or possibly a target ID to the schedule update (375c). Typically, “schedule updates” that correspond to programs that are currently being broadcasted are assigned the top priority to ensure that they are sent ahead of any other data previously queued for transmission. At the appropriate time, the schedule update information will be loaded into the appropriate directory/subdirectory of the HMC configuration server 316 (375d).

The schedule update information may comprise only basic data 362, or a subset of the basic data, such as a revised start time and a revised stop time. After this information is loaded into the HMC configuration server 316, the updated program guide information is broadcasted to all of the active media centers 334 (375e). Upon receiving the updated schedule data, the HMC configuration agent 336 at each media center 334 will either store the schedule data in the HDD 340 or filter out all of the unnecessary versions of the schedule data based upon its associated target data (375f). After this, the HMC configuration agent 336 at each media center 334 will update the EPG data on its corresponding HDD 340 with the new schedule data that has just been broadcasted (375g). After this step, the media center 334 determines if the schedule update affects any future recordings (375h). If the update does affect future recordings, then these recording settings (375i) are updated to reflect the changes. In addition, the user can be notified of any changes to these recording settings (375k).

Next, the media center 334 determines if the schedule update cancels a program that is presently being recorded (375l). If so, then the recording of the current program is stopped (375m). The recorded program is then marked as being incomplete (375n) and the user can be notified of the cancellation of the recording (375o). After this, the media center 334 determines if the update moves the start time of a program currently being recorded to a time earlier than the save time buffer (375p), that is, to a time earlier to when the recording began. If so, then the program is marked as being incomplete (375q) and the user can be notified of its cancellation (375r). Finally, the media center 334 determines if the update moves ahead the end time of a program currently being recorded. This kind of “schedule updates” are typically used when a program is running long and, therefore, the actual end time is yet unknown. In these situations, the end time indicated in the “schedule update” is just a rough estimation whose goal is to push ahead the recording of the program.

As long as the program continues to run long, the synchronized EPG server 300 can keep on issuing “schedule updates” in real-time restating the stop time of the program. The first update has to arrive early enough so that recording devices do not stop recording the program that still has not finished. As has been described above, media centers keep on recording a few minutes (the “safe time buffer”) after the program is scheduled to end in the original EPG. Therefore, the first “schedule update” for a program that is running long has to arrive before the safe time buffer has ended.

This first “schedule update” will restate the end time of the program as occurring, for instance, 10 minutes later. After that, if the program continues to run, the synchronized EPG server can send more “scheduled updates” a few minutes before the restated end time elapses, so that media centers continue recording until no more “scheduled updates” are received. This embodiment is consistent with a broadcast model in an unreliable communications network, where data packets sent by the synchronized EPG server 300 might be lost at any time. In such networks, it would be dangerous to rely on a different solution that required a special packet to stop the recording, since it could get lost and the media center would then continue recording forever. The solution of sending a series of “scheduled updates”, as described in the previous paragraph, is better because in the worst case if a packet is lost the system will stop the recording too early, but at least it will not continue to record forever. On the other hand, on reliable networks, when a program runs late it is better to simply issue a single “schedule update” that moves the end time several hours ahead, and then send a “trim update” (discussed below) when the program actually ends. At this point, the schedule update process is complete at the media center 334 (375s).

Although the combination of “schedule updates” and the use of safe times ensures that the entire program is recorded, additional undesired lead-in and follow-on programming is attached to each recorded program. This not only wastes hard disk space that could otherwise be used for recording other programs, but also is annoying for the user because all recordings begin with a fragment of the previous program or the commercial break aired before the desired program. Accordingly, “trim updates” can be utilized to synchronize the recording start and stop times with the actual start and stop times for a program. Once each media center 334 is aware of the actual start and stop times for a program, the safe time buffers preceding and following the actual start and stop times, respectively, can be erased. Unlike in the prior art, these EPG updates are sent to media centers after the program has finished.

A flow diagram depicting one embodiment of a “trim update” process is depicted in FIG. 3D. According to FIG. 3D, the process starts (385a) when the actual program start and stop times are entered from the administrative terminals 328 (385b). Typically, this occurs after each program is complete.

Next, the EPG server 302 generates EPG data corresponding to the actual program start and stop times (385c). This data is then sent to the HMC configuration server 316 as a trim update (385d). Although this data is sent directly to the HMC configuration server 316, it is also stored in the database repository 320 so that a complete copy of the EPG database 361 is maintained at the synchronized EPG server 300. Unlike other kinds of updates, “trim updates” do not go through the content manager/scheduler 312, since they are always urgent in nature. After the HMC configuration server 316 receives the trim update information, it is broadcast to each of the active media centers 334 (385e).

Upon receiving the trim update information, each of the media centers 334 will either store the trim update data or discard any irrelevant trim update information depending upon its associated target data (385f). If the trim update information is targeted to the media center 334, then the HMC configuration agent 336 will update the EPG database 361 on the HDD 340 with the actual program start and stop times (385g), which may also be in real-time with changes in the scheduled programming. This process may be performed by an HMC configuration agent 336 that is located at each of the respective media centers 334.

Next, the media center 334 will determine if the trim update affects any program currently being recorded (385h). In this case, if the end time in the “trim update” is already in the past (385i), the recording is stopped and the recorded program is then marked as being complete (385j). On the other hand, if the end time is still in the future (385i), the trim command is processed as if it were a “schedule update.” First, it is determined if the trim update postpones the stop time of a program being recorded (385p), and if so, the stop time for the recorded program is postponed by the specified amount (385q). If not, then the process moves to a determination of whether the trim update affects a previously recorded program (385r, see below). In some embodiments, trim commands are always sent when the program has ended, and therefore, they always carry an end time that is in the past.

As mentioned above, the process moves to a determination by the media center 334 of whether the update affects any previously recorded programs (385r). Note that this also includes the recordings that have been finished by this same “trim update”, as described above. If the trim update does affect a recorded program, then the portion of the “safe time” buffer that precedes the actual program start time will be deleted (385s). Similarly, the portion of the “safe time” buffer that follows the actual program stop time will also be deleted (385t). Although in most cases the segments trimmed fall within the safe time buffers, in general, the trim update can cause the removal of as much recorded time as specified by the new start and end time. At this point, the trim update process is complete (385u).

As described previously, the “annotation update” enables the annotation of broadcast content as it occurs. For example, if a sports event is being recorded, then the times at which certain periods of the event occur (e.g., innings, quarters, periods, etc.) can be marked and broadcast to the media center 334. In addition, the occurrence of special events, such as a goal in hockey or soccer, or a homerun in baseball, can be marked and broadcast to the media centers 334. Such annotation updates may be sent in real-time with the occurrence of the event during broadcast of the program. This allows a user to select certain key events to view from a particular program that has been recorded. Another aspect of this feature is the marking of commercial interruptions for a broadcast program. By doing this, a viewer can determine when commercial interruptions begin and end for a recorded program. Yet another example of a service that can be implemented using “annotation updates” is a news clipping service that marks all the occasions where a certain type of event (the appearance of certain politician, or company, or kind of sport) is aired in any channel. These annotations can be used by a recording device (i.e., media center 334) to tailor recordings to the specific interests of the user.

A representative process by which an “annotation update” of the electronic program guide database 361 is performed is depicted in FIG. 3E. An “annotation update” can be performed several times per day. In FIG. 3E, the process starts (380a) by first updating the EPG database 361 with annotation information from the administrative terminals 328 (380b). Next, the content manager/scheduler 312 assigns a priority, a schedule for the delivery, and, in some embodiments, target data, to the annotation update (380c). At the designated time, the annotation update data will be loaded into an appropriate directory or subdirectory of the HMC configuration server 316, which acts as a transfer queue for the network interface 318 (380d).

After this, the annotation update data is broadcast to all active media centers 334 (380e). Next, the HMC configuration agent 336 at each media center 334 will either store the annotation update, or discard all unnecessary annotation update data (380f). Finally, the EPG data on each of the media centers 334 will be will be updated with the annotation data (380g). At this point, the annotation update of the electronic program guide database 361 is complete (380h). The constant movements of programs and the updating of start and end times introduced by all the different kinds of updates previously described, makes it important to be able to resolve and clear recording conflicts in accordance with changing program schedules, which is even more beneficial when done in real-time as disclosed herein.

Conflicts can occur when multiple resources within the system request recording of different video broadcast programs at the same time. For example, in a system having a single tuner, if the recordings of two different video broadcasts are requested simultaneously, there will be a conflict. In a system having two tuners, if the recordings of three different video broadcasts are requested simultaneously, there will be a conflict. Such conflicts can occur, for example, if multiple users all schedule a recording for the same time, or one of two programs not initially scheduled for the same time is rescheduled, such that it then overlaps with the requested recording of another program. In some applications, the processes for resolving schedule conflicts may be different for programs that are fully or substantially overlapping relative to programs that are almost abutting. An exemplary embodiment of a conflict resolution process is included below, however, no limitation to any particular process is intended or should be implied.

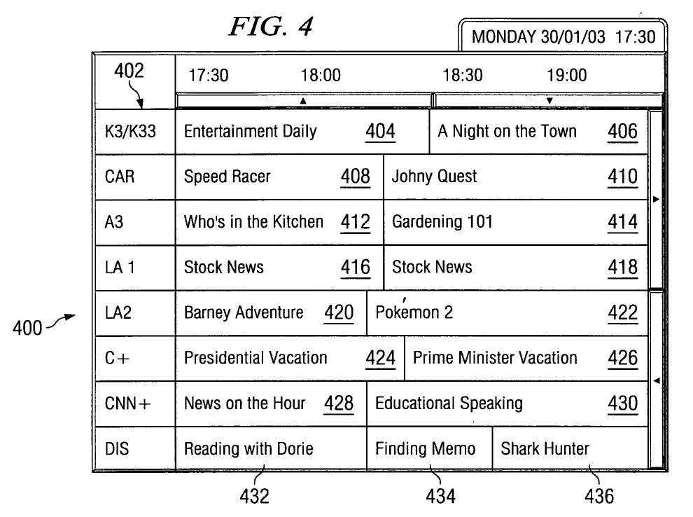

FIG. 4, which comprises a screen shot of the EPG user interface screen 400, provides an illustration of the different ways in which programs can overlap. At the top of the EPG interface screen 400 is a timeline 402, which lines up with the programs (404-436) shown below it. The EPG screen 400 shown here would comprise in most digital television systems a mere cross-section of available programs, and different cross-sections of the programs can be accessed through key strokes or by paging up or down through the channel listings. Note that in this channel listing, not all the programs end at the same time. For example, on channels T5, A3, and TVE1, the first three programs 408, 412, 416 all appear to be scheduled to end at the same time, which in this example is approximately 6:10 p.m. Three other programs 420, 428, 432 in this example end about 5 minutes earlier, i.e., at approximately 6:05 p.m. Another program 404, on channel K3/K33 is ending at approximate 6:15 p.m., while yet another program 424, on channel C+ appears to be ending just a minute or two after that, for example, at 6:17 p.m.

Still referring to FIG. 4, certain programs appear to be abutting in time, for example, program 408 would be considered to abut in the program schedule with programs 410, 414 and 418, as would programs 412 and 416. Despite that, a user could avoid possible conflict between the recording of programs in the two different timeslots indicated—the 5:30-6:15 timeslot and the 6:15 to 7:30 timeslot—by recording the adjacent programs in the same channel. Time variations from one channel to another, and the high probability that a program runs long a few minutes, preclude any confidence that there will not be conflict between two programs on different channels that appear to abut in the programming schedule. Such programs, which appear not to conflict, would also generally be considered as potentially conflicting by the conflict resolution procedures. Other examples of nearly abutting programs would include programs 424 and 406, where the scheduled start time of program 406 (7:15) appears to just slightly overlap the scheduled in time of program 424 (7:17) and programs 416 and 422, where there appears to be an approximate five-minute overlap between the end of the first program 416 and the start of the second program 422.

Other programs appear to completely or substantially overlay in this schedule. For example, of the first programs shown here in the 5:30 timeslot, all of these programs 404, 408, 412, 416, 420, 424, 428, and 432 appear to substantially overlap with each other. While the conflict resolution process can monitor these programs for outright changes of schedule, they do not appear likely to be susceptible to having their conflicts cleared by minor schedule variations that may occur. Accordingly, in certain embodiments it may be desirable to treat these conflicts differently and to force a specific choice between the recording of one program and the recording of another.

There will also be many programs that are both non-overlapping and non-abutting. For example, program 436 is well-separated from at least all of programs 408, 412, 416, 420, 428, and 432, and depending on definitions, even from programs 404 and 424. When recording two of these well-separated programs, in general, conflict resolution should be unnecessary, unless one or both of the programs is rescheduled such that they then exist during overlapping time periods.

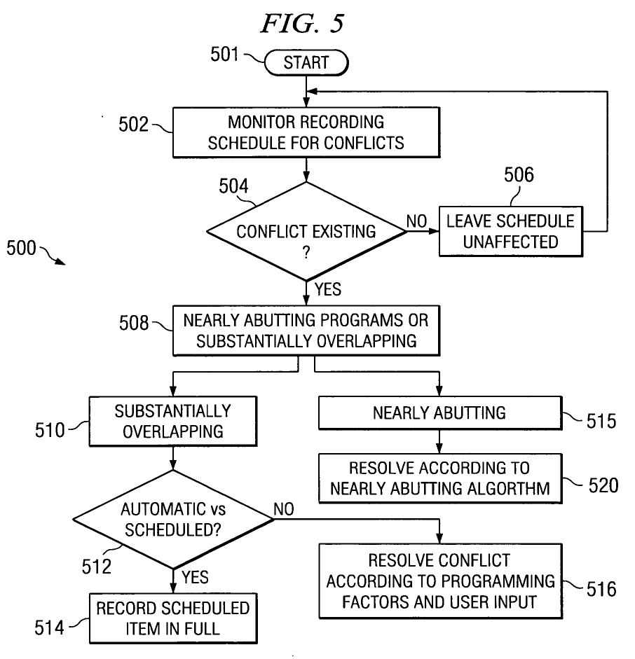

FIG. 5 provides a flowchart for an exemplary resolution of recording conflicts. The general process for conflict resolution 500 starts at Start Block 501. The system continually or periodically monitors for schedule conflicts in accordance with Block 502. Should no conflict exit, the process proceeds, according to Decision Block 504, to leave the recording schedule unaffected (per Block 506) and continues monitoring for conflicts at Block 502 for updates both to the requested recordings and the schedules for those requested recordings per the EPG updates.

In certain embodiments, the algorithms for resolving substantially overlapping or nearly abutting conflicts may be different. In those instances, at Block 508, branch decisions are made according to whether the conflicting programs are substantially overlapping or nearly abutting. If the conflicting programs are substantially overlapping, then the process continues to Block 510 for “substantially overlapping” conflicts.

In the present embodiment, according to a design decision, the programs selected for recording automatically by the media center are dismissed in favor of those selected by the user as scheduled recordings. Examples of automatic recordings include those started by the media center on its own, without user intervention, according to some predefined rules, such as the recordings scheduled due to “annotation updates”, or the recordings of movies with a quality of five stars as indicated by the EGP, etc.

Accordingly, at Decision Block 512, the question is posed whether the conflict is between a recording chosen by an automatic recording agent recording and a scheduled recording. If it is, according to Block 514, the scheduled item is recorded in full. In general, in the “substantially overlapping” branch beginning at Block 510, the program that “loses” in the conflict is not recorded at all. Further following Decision Block 512, if the conflict is not between an automatic recording agent recording and a scheduled recording, then by Block 516 the higher priority recording is chosen for recording—whether according to a choice between two automatic recording agent recordings or two scheduled recordings.

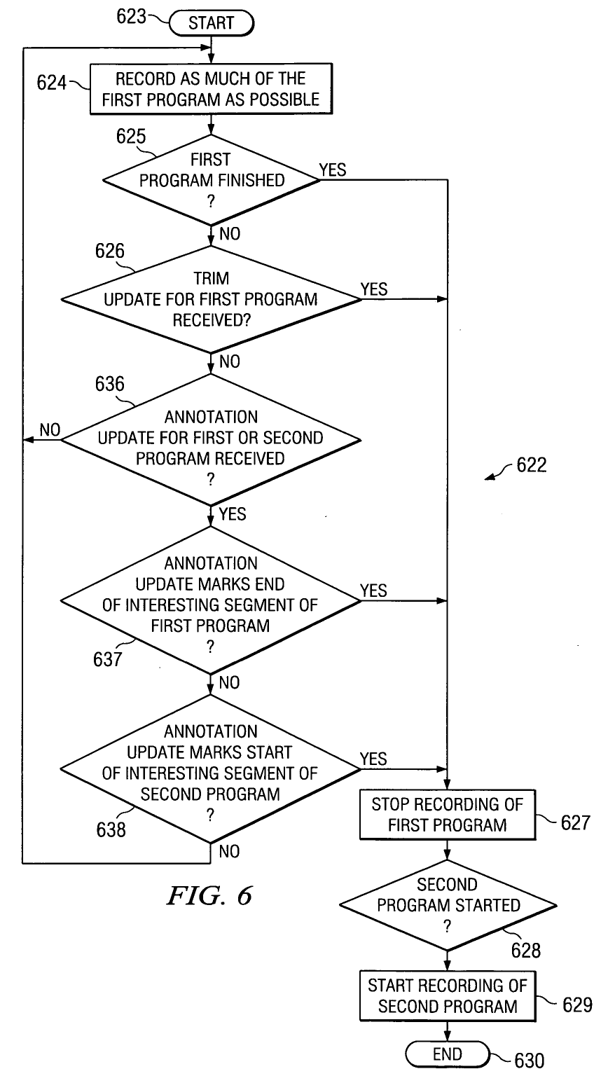

The second branch, beginning at Block 518 in this embodiment, handles the “nearly abutting” conflict resolution process, in which the media center attempts to record as much as possible of both competing programs. Within this second branch, from Block 518 operation of the program proceeds to Block 520, where the conflicts are resolved according to an algorithm for handling these nearly abutting programs. The nearly abutting process essentially calls a sub-routine, illustrated as 622 in FIG. 6.

FIG. 6 illustrates a flow chart of an exemplary process 622 for the resolving of the conflict, which begins at Block 623. At Block 624, the algorithm develops a priority scale designated as P1, P2 for the conflicting programs, where the P1 indicates a weighted importance number for the first program in the sequence, and wherein P2 indicates a weighted priority number for the second program in the sequence. At Block 624, the recording process continues for the first of the recordings such that the first program is recorded as much as possible up until when the conflict arises between the two adjacent, or nearly abutting, programs.

At Decision Block 625, if it is determined that the first program has finished. If so, the process moves to Block 627 where recording of the first program is stopped. If, however, it is determined that the first program has not finished, the two programs are conflicting because the second program has started while the first program is still ongoing. Therefore, a decision has to be made as to which of the two programs should receive the priority for the recording. In this embodiment, the second program has received priority, and thus recording of the second program begins at Block 629, and a detailed discussion of the prioritization process (through Blocks 626-638) is provided below. Regardless of whether or not the first program or the second program has the higher priority number, given the importance of the program schedules and the small overlap between them, it is especially important that the latest EPG update have been received when resolving the conflict between the two slightly overlapping programs. Therefore, in both branches the process monitors the EPG for scheduled updates, trim updates and other program updates, such as annotation updates, regarding the program schedules for the conflicting programs.

Trim updates are useful when the two programs are aired one after the other on the same channel. In this situation, it is clear that the second program will never start before the previous program has ended. Without trim updates, however, the media center does not know the exact time when a program ends, and therefore it is easy that it would record fragments of a program in the file corresponding to the other program. With trim updates, on the other hand, the media center continues to record the first program up until the end of the safe time, and then switches to record the second program. If while recording the first program a trim update arrives announcing the end of this program, the media center simply stops this recording and starts the second one, beginning at that point the initial safe time of the second recording.

Annotation updates can also be particularly useful in resolving slightly overlapping program conflicts. For example, television shows and movies will often include credits at their end. If an annotation update was included at the end of such programs, users may be happy to forego having those credits in order to transfer recording to the second program of the two conflicting, nearly abutting programs. Sports programs often have pre-game introductions and other coverage, and will also often include some post-game summary. Annotation marks placed at the beginnings and endings of such programs could enable the recording of the particular pre- and post-game coverage to be foregone in favor of other scheduled recordings.

If the conflict is resolved by the trim updates, schedule updates, and/or annotation updates, then the start time for the second program or the end time for the first program would be shifted in such a way that both programs can be recorded without losing any content of interest. If, however, the conflict cannot be resolved through such updates, then factors are weighed between the two programs to decide which of the two programs should be recorded in its entirety and which should be cut-off (at its beginning or end, depending on whether the cut-off program is the first of the two programs or the second).

The process weights various factors in deciding which of the two conflicting programs should be cut off, and which should be recorded in its entirety. Annotation updates could be used in this portion of the process, as described above. For example, if a program would only have its credits cut off, or if a sports event would only have pre- or post-game coverage cut off, then that program could be given a low priority number for the resolving of the conflict between the two programs. Thus, at Block 636 an annotation update for the program would have been received, and at Blocks 637 and 638 such updates could mark either the end of a “more interesting” segment of the first program (Block 637) or the beginning of a more interesting segment of the second program (Block 638). Of course, other factors could be used in weighing between the two programs. In an advantageous embodiment, programs scheduled by the users would generally have higher priorities than those suggested by the automatic recording agent (e.g., see Block 512 in FIG. 5), and, in certain embodiments, the user-scheduled programs are always recorded in their entirety over those suggested by the automatic recording agent.

As another example, if one of the programs is going to be broadcast at a later time, then the other program that perhaps is only appearing once or is appearing at its last scheduled appearance should have the higher priority than the other program. The programs scheduled by or suggested for certain users may be assigned to have higher priority than the programs of other users, such as, for example, the parents and administrators of the media center may have a higher priority for their recordings than would children in the household. Certain types of programming may also be given a higher priority than others. For example, news programs might be given a higher priority than sports, dramas or comedies, and sports may be given a higher priority than dramas or comedies. These preferences could, if desired, be set up by the system administrator and/or the users of the media center.

Having assigned priority factors, if the first program priority factor (P1) is greater than or equal to the second program priority factor (P2), then, according to Block 624, all of the first program would be recorded. According to this path, the second program would then be immediately recorded upon the completion of the recording for the first program (Blocks 625 and 627). The second branch, when P2 is greater than P1, begins at Block 626. Here, the first program is recorded up until immediately before the second program's most-recently-updated start time, or up until some time that has a small safety margin relative to the beginning of the second program. At Blocks 627 and 628, the second program is immediately recorded (629) at its schedule start time whereas the first program would be cut-off immediately at that time.

While various embodiments of the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of synchronizing electronic program guide data with actual broadcast programming, the method comprising:
storing electronic programming guide data in a data repository, the electronic programming guide data comprising broadcast programming data associated with broadcast programming;
transmitting the electronic programming guide data across the communications network to recording devices, the recording devices generating an electronic program guide for display to a programming viewer using the electronic programming guide data;
receiving updated broadcast program data associated with changes in the broadcast programming substantially in real-time with the changes;
generating synchronization data based on the updated broadcast program data and substantially in real-time with receiving the updated broadcast program data; and
transmitting the synchronization data across the communications network to the recording devices substantially immediately after generating the synchronization data.

2. A method according to claim 1, wherein the synchronization data comprises at least one selected from the group consisting of:
full updates configured to update all of the electronic program guide data;
schedule updates configured to update the electronic program guide data with changes in the broadcast of broadcast programming;
trim updates configured to update the electronic program guide data with start and end times of specific broadcast programming scheduled for recording; and
annotation updates configured to update the electronic program guide data with timing information that corresponds to specific events occurring during specific broadcast programming scheduled for recording.

3. A method according to claim 2, further comprising prioritizing the transmitting of the synchronization data based on type of update.

4. A method according to claim 3, wherein prioritizing further comprises preempting one update with another update being transmitted.

5. A method according to claim 2, wherein the schedule updates comprise updates for programming yet to be broadcasted and programming presently being broadcasted.

6. A method according to claim 2, further comprising transmitting synchronization data comprising a schedule update when an end time for programming has changed from an original end time set forth in the original electronic program guide data.

7. A method according to claim 6, further comprising transmitting schedule updates periodically until broadcast of the programming ends.

8. A method according to claim 6, further comprising transmitting a single schedule update when the end time for programming extends past it originally scheduled end time, and transmitting a single update when the programming actually ends.

9. A method according to claim 1, wherein the communications network comprises at least one selected from the group consisting of:
an analog terrestrial television network;
an analog terrestrial radio network;
a digital terrestrial television network;
a digital terrestrial radio network;
a digital cable television network;
a digital satellite communications network; or
a telephony-based communications network.

10. A method according to claim 1, wherein the communications network comprises a packet-based network.

11. A method according to claim 1, wherein the broadcast programming comprises terrestrial television programming, satellite television programming, terrestrial radio programming, or satellite radio programming.

12. A method according to claim 1, wherein the synchronization data comprise a target ID, and transmitting synchronization data comprises transmitting synchronization data for use by specific recording devices based on a target ID.

13. A method according to claim 1, wherein receiving updated broadcast programming data comprises updating the stored electronic program guide data with updated broadcast program data associated with changes in the broadcast programming.

14. A method according to claim 13, wherein generating synchronization data further comprises generating synchronization data based on the updated broadcast program data in response to updating the stored electronic program guide data.

15. A method according to claim 1, wherein receiving updated broadcast program data associated with changes in the broadcast programming comprises receiving the updated broadcast program data from broadcasters of the broadcast programming.

16. A method according to claim 1, wherein transmitting synchronization data comprises transmitting synchronization data without prompting for updates by the recording devices.

17. A method of accurately recording broadcast programs with a recording device, the method comprising:
receiving electronic program guide data over a communication network, the electronic program guide data comprising broadcast program data associated with broadcast programming and used to generate an electronic program guide for display to a programming viewer;
scheduling recording of the broadcast programming by the recording device based on the electronic program guide data;
receiving synchronization data over the communications network, the synchronization data comprising real-time updates to the broadcast program data that are associated and substantially in real-time with changes in the broadcast programming; and
altering the scheduled recording of the broadcast programming in response to receiving the synchronization data in order to accurately record programs from their actual beginning to their actual end.

18. A method according to claim 17, wherein the receiving synchronization data further comprises updating the electronic program guide data with the synchronization data, and wherein altering the scheduled recording comprises altering the scheduled recording of the broadcast programming based on the updated electronic program guide data.

19. A method according to claim 18, wherein the synchronization data comprises at least one selected from the group consisting of:
full updates configured to update all of the electronic program guide data;
schedule updates configured to update the electronic program guide data with changes in the broadcast of broadcast programming;
trim updates configured to update the electronic program guide data with start and end times of specific broadcast programming scheduled for recording; and
annotation updates configured to update the electronic program guide data with timing information that corresponds to specific events occurring during specific broadcast programming scheduled for recording.

20. A method according to claim 19, wherein the schedule updates comprise updates for programming yet to be broadcasted and programming presently being broadcasted.

21. A method according to claim 19, further comprising receiving synchronization data comprising a schedule update when an end time for programming has changed from an original end time set forth in the original electronic program guide data.

22. A method according to claim 21, wherein the updated end time exceeds the original end time, and wherein altering the scheduled recording comprises continuing an ongoing recording until the updated end time.

23. A method according to claim 21, wherein the updated end time is earlier than the original end time, and wherein altering the scheduled recording comprises stopping an ongoing recording if the updated end time has already passed.

24. A method according to claim 21, further comprising receiving schedule updates periodically until broadcast of the programming ends.

25. A method as recited in claim 19, wherein altering the scheduled recording comprises editing out a beginning portion and an end portion of a recording in accordance with a trim update received over the communications network.

26. A method as recited in claim 19, wherein altering the scheduled recording comprises storing annotation updates received over the communications network for later access by the viewer during a playback of the recorded programming.

27. A method as recited in claim 19, wherein altering the scheduled recording further comprises recording only related portions of the programming identified by annotation updates received over the communications network.

28. A method according to claim 17, wherein the communications network comprises at least one selected from the group consisting of:
an analog terrestrial television network;
an analog terrestrial radio network;
a digital terrestrial television network;
a digital terrestrial radio network;
a digital cable television network;
a digital satellite communications network; or
a telephony-based communications network.

29. A method according to claim 17, wherein the communications network comprises a packet-based network.

30. A method according to claim 17, wherein the broadcast programming comprises terrestrial television programming, satellite television programming, terrestrial radio programming, or satellite radio programming.

31. A method according to claim 17, further comprising marking a scheduled recording as incomplete if the synchronization data comprises an update altering the start time of programming scheduled to be recorded to a time earlier than when the recording was started.

32. A method according to claim 17, further comprising solving conflicts in scheduled recordings that occur when two recordings are broadcast at overlapping times using the received synchronization data.

33. A method according to claim 32, wherein solving conflicts further comprises solving conflicts in overlapping first and second scheduled recordings by receiving an annotation update indicating when a main portion of the first program has finished, and starting the recording of the second program after the recording of the main portion of the first program is finished.

34. A method according to claim 32, wherein a first scheduled recording is scheduled by the viewer and a second scheduled recording is schedule automatically, and wherein solving conflicts comprises canceling the second scheduled recording.

35. A method according to claim 17, wherein receiving synchronization data further comprises receiving synchronization data comprising updates to the broadcast program data provided by broadcasters of the broadcast programming.

36. A method according to claim 17, wherein receiving synchronization data comprises receiving synchronization data without prompting for updates by the recording device.
